(19) United States
(12) Patent Application Publication
(10) Pub. No.: US 2011/0252960 A1
(43) Pub. Date: Oct. 20, 2011

(54) MECHANICAL VENTILATOR

(75) Inventor: Moran BACHAR, Haifa (IL)

(73) Assignee: Flight Medical Innovations Ltd., Lod (IL)

(21) Appl. No.: 13/094,887

(22) Filed: Apr. 27, 2011

(51) Int. Cl. F01B 9/00; F16K 1/00

(52) U.S. Cl. 92/140; 251/331

(57) ABSTRACT

A reciprocating device, comprising:
a motor;
at least one crank mechanism attached to the motor;
at least one rod attached to the crank mechanism; and
at least one sleeve surrounding at least a portion of the at least one rod, adapted to dampen optional vibrations of the rod.

### FIELD AND BACKGROUND OF THE INVENTION

The present invention, in some embodiments thereof, relates to mechanical ventilators and, more particularly, but not exclusively, to mechanical ventilators using a reciprocating device for converting rotary to linear motion or vice versa.

Reciprocating devices for use in mechanical ventilators are well known in the art.

U.S. Pat. No. 5,762,480 to Adahan described a reciprocating machine associated with a supply of working fluid, and includes rotational power apparatus having a rotational motion transfer member; a cylinder defining a longitudinal axis and having a first end at which are located working fluid input and output apparatus, and further having a second end; a piston located within the cylinder and arranged for linear, reciprocating travel along the longitudinal axis between the first and second ends; a connecting rod having a first end connected to the piston, and further having a second end portion; and linkage apparatus.

U.S. Pat. No. 7,654,802 to Crawford Jr. et al. describes a reciprocating drive apparatus having a driving device and a driven device, one of the devices comprising a reciprocating member mounted for movement along a longitudinal axis. At least one rotary member is coupled to one of the devices and a linear bearing assembly has a linear guide rail and a linear slide member with an end coupled to the other device. A connecting link has a first end pivotally connected to the rotary member and a second end pivotally linked to the slide member. Where the reciprocating member is the driven device, rotation of the rotary member will cause the reciprocating member to move back and forth along the longitudinal axis.

The disclosures of the above publications are incorporated herein by reference as if fully set forth herein.

### SUMMARY OF THE INVENTION

An aspect of some embodiments of the invention relates to a sleeve for the rods or rods of a reciprocating device.

In some embodiments of the invention, a mechanical ventilator includes an air compressor or pump in a housing or manifold. An aspect of some embodiments relates to at least one inlet or outlet valve in the manifold for controlling the flow of air, where the plug and diaphragm of the valve are formed of a single piece.

An aspect of some embodiments of the invention, relates to a housing for the reciprocating device and air chambers, where the contact points of the rod with the housing is adapted to reduce friction and noise.

According to an aspect of some embodiments of the present invention there is provided a reciprocating device, comprising:

a motor;

at least one crank mechanism attached to the motor;

at least one shaft or rod attached to the crank mechanism; and

at least one sleeve surrounding at least a portion of the at least one rod, adapted to dampen optional vibrations of the rod.

According to some embodiments of the invention, the motor provides a rotary motion and the at least one crank mechanism is adapted to transfer the rotary motion to reciprocating linear motion of the at least one rod.

According to some embodiments of the invention, at least one crank mechanism comprises two crank mechanisms and at least one rod comprises two rods, each connected to a crank mechanism.

According to some embodiments of the invention, at least one sleeve comprises two sleeves, each surrounding at least a portion of one of the two rods.

According to some embodiments of the invention, the at least one sleeve surrounds between 25%-60% of the length of the at least one rod.

According to some embodiments of the invention, the device further comprises at least one bushing in which the at least one rod moves, and wherein the sleeve surrounds the portion of the rod that does not move in the bushing.

According to some embodiments of the invention, the sleeve has a thickness of at least 0.2 mm.

According to some embodiments of the invention, the sleeve is made of a material having a hardness of between about 30-65 Shore A.

According to some embodiments of the invention, the sleeve is made of silicone.

According to some embodiments of the invention, the sleeve is made of rubber. According to an aspect of some embodiments of the present invention there is provided a valve, comprising:

a valve housing having a first aperture and a second aperture; and

a unitary base element, comprising:
a diaphragm for covering the second aperture; and
a plug for plugging in the first aperture.

According to some embodiments of the invention, the diaphragm comprises two disks of different diameters. According to some embodiments of the invention, the diaphragm comprises of a single disk with different thickness.

According to some embodiments of the invention, the plug comprises an end distal from the diaphragm having a shaft and a cap with a larger diameter than the first aperture for holding the base element in the housing.

According to some embodiments of the invention, the second aperture is ring shaped and comprises a plurality of ribs.

According to some embodiments of the invention, the life of the valve is at least 405 million cycles at a speed of about 20 m/s.

According to some embodiments of the invention, the unitary base element is made of silicone.

According to an aspect of some embodiments of the present invention there is provided a manifold housing, comprising:

two bushings at an upper surface of the housing, the bushings having apertures for rods; and

at least two air chambers having air inlets and outlets,

wherein the wall thickness at the bushings at the upper surface of the housing differs by less than 10%.

According to some embodiments of the invention there is provided a compressor or pump comprising a manifold housing according to the aspect of the invention described above, and further comprising:

a rotary motor for operating the rods; and

two crank mechanisms, each attached to a shaft or rod, for transferring the rotary motion of the motor to reciprocating linear motion of the shafts into the bushings.

According to some embodiments of the invention, the motor is situated at the upper surface of the housing, between the two bushings.

According to some embodiments of the invention, the wall of the housing at the upper surface of the motor is about 2 mm thick.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A and 1B are partially cross-sectioned side and cross-sectional front views of a mechanical ventilator according to some embodiments of the invention;

FIG. 2 is a schematic illustration of a manifold wall for the ventilator of FIGS. 1A and 1B according to some embodiments of the invention;

FIGS. 3A and 3B are partially cross-sectioned side and cross-sectional front views of a mechanical ventilator according to some other embodiments of the invention;

FIGS. 4A and 4B are a cross-section and a bottom view, respectively, of a one-way valve as known in the prior art; and

FIG. 5 is a cross-section of a one-way valve according to some embodiments of the invention.

### DESCRIPTION OF SPECIFIC EMBODIMENTS OF THE INVENTION

The present invention, in some embodiments thereof, relates to mechanical ventilators and, more particularly, but not exclusively, to mechanical ventilators using a reciprocating device for converting rotary to linear motion or vice versa.

In some embodiments of the invention, the reciprocating device comprises a crank mechanism and two piston shafts (or rods) that move linearly inside bushings. In some embodiments, the rods bend slightly during operation due to the structure of the crank mechanism and should therefore be flexible. The rods are therefore made relatively thin, optionally between about 0.5 mm-1.5 mm in diameter, for example 1 mm in diameter. During operation, the rods tend to vibrate, apparently due to their thinness and friction against the bushing, which can cause high pitched noise.

According to an aspect of some embodiments of the invention, a sleeve is provided on at least a portion of the rods, optionally in order to reduce the vibrations and noise. In some embodiments, the sleeve is provided on the entire portion of the rods that does not pass through the bushings. In some embodiments, the sleeve is provided on between 25%-60% of the rods length, for example between 40%-60% of the rods length, such as at least 50% of the rod length. Optionally, the sleeve is provided on an end portion of the rod. In some embodiments, the sleeve is between about 0.2 mm-1 mm thick. Optionally, the sleeve has a thickness substantially the same as the diameter of the rods.

Optionally, the sleeve surrounds the entire diameter of the rod. Alternatively, the sleeve surrounds less than the entire diameter of the rod, leaving a slit along the rod's length which may allow placing the sleeve around the rod without taking the system apart. For example the sleeve may surround about 90% or more of the diameter of the rod. In some embodiments, the sleeve surrounds less than 90% of the rod's diameter.

In some embodiments, the sleeve is made of a material that can dampen vibrations of the rod. Optionally, the sleeve is made of a material having a density of about 1 g/cc. Optionally, the sleeve is made of a material having a hardness of between about 30 Shore A to 65 Shore A, for example between 40-65 Shore A. Optionally, the sleeve is made of a material having tensile strength of between about 9-20 N/mm². Optionally, the sleeve is made of a material having elongation of between about 350%-500%. Optionally, the sleeve is made of a material having tear resistance of between about 19-40 N/mm. Optionally, the sleeve is made of silicon or rubber.

The sleeve according to some embodiments of the invention is also usable in prior art devices such as for example the reciprocating devices of U.S. Pat. No. 5,762,480 and U.S. Pat. No. 7,654,802 incorporated herein by reference.

In some embodiments of the invention, the reciprocating device functions as an air compressor having a manifold with air-inlets and outlets, where the crank mechanisms are externally attached to the manifold and the piston rods move linearly into the manifold.

An aspect of some embodiments of the invention relates to a one way (inlet or outlet) valve for the manifold where the plug and diaphragm of the valve are formed as a single unitary piece. The prior art valves comprise two silicon disks of different diameters and a plug for securing the silicon disks together and attaching them to a valve housing. During operation of the compressor, the silicon disks bend to enable air flow in one direction. The present inventors have found that friction between the disks and the plug occurs. This results in wear of the disks and requires relatively frequent valve replacement.

The inventors of the present application have found that the disks and plug can be provided as a single (unitary) element, thereby practically eliminating the friction between the elements and substantially increasing the life of the valve.

In some embodiments of the invention, the valve comprises a housing having an aperture and a unitary element comprising a diaphragm and plug to be inserted through the aperture. Optionally, the diaphragm comprises a single disk of different thickness. Optionally, the diaphragm comprises of two silicon disks of different diameters which are connected at the side of the plug and are provided as a single unitary piece with the plug.

In an embodiment of the invention, the plug comprises an end distal from the diaphragm having a shaft and a cap with a larger diameter than the shaft, where the shaft is inserted into the aperture and where the diameter of the cap is larger than the diameter of the aperture of the housing so as to hold the diaphragm in the housing. In some embodiments, the diaphragm is made of silicon or rubber. Optionally, the housing is made of plastic.

In the prior art, the manifold housing comprises a generally box shaped housing having at least two air chambers and air inlets and outlets. A compressor or pump is positioned in a narrow extension on an upper wall of the housing. Crank mechanisms, operated by a motor in the extension, are connected to the compressor at the two sides of the extension such that they are situated on top of the upper wall of the housing. Each crank mechanism is connected to one end of a piston rod which enters the housing through an aperture in a bushing on the upper wall of the housing. The other end of each of the piston rods is connected to a piston.

In the prior art, the upper wall of the housing is asymmetric in the sense that one of the sides of the housing at the entrance of the rod into the bushing is thinner than the other in order to allow the motor to be inserted into the housing. This however, reduces the available length for the bushing allowing rods to move, causes wear and sometimes causes the compressor to fail. In addition, the movement results in excessive noise during compressor operation.

An aspect of the present invention refers to a housing where the upper wall has a substantially same thickness at both sides thereof at which the two rods enter the housing. In some embodiments of the invention, the wall at the upper surface of the housing extension is also made thicker than in the prior art. Optionally, the wall at the upper surface of the housing extension is about 2 mm thick, or more.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

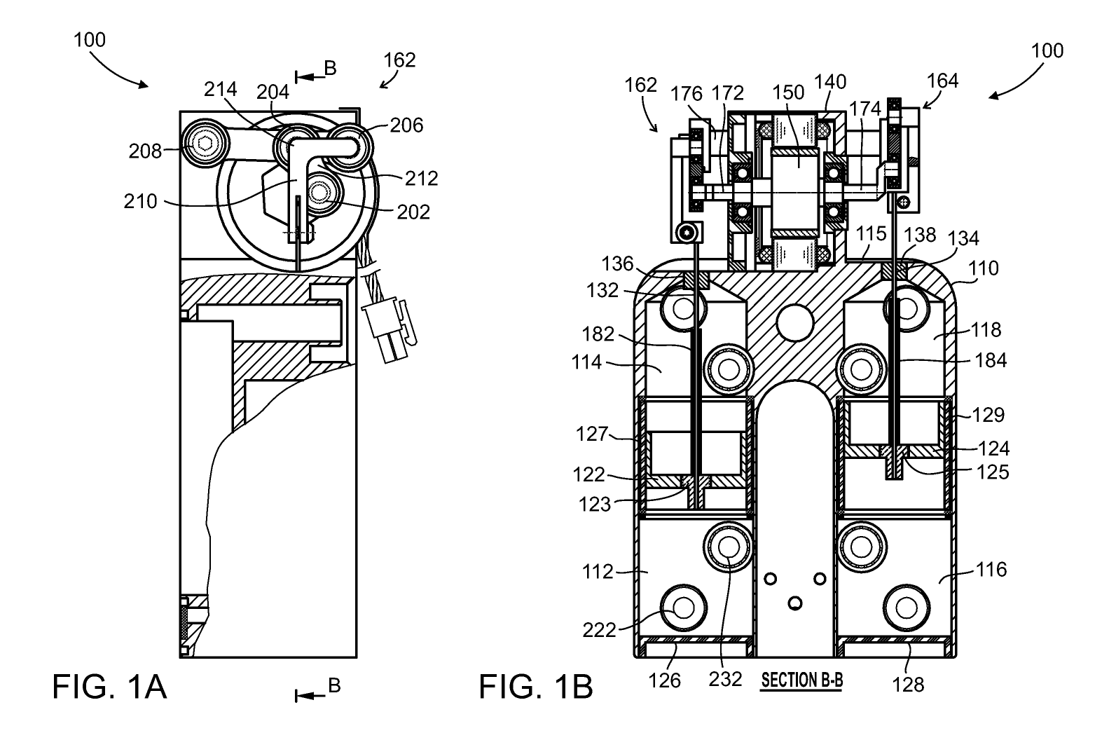

Referring now to the drawings, FIGS. 1A and 1B are partially cross-sectioned side and cross-sectional front views of a mechanical ventilator 100 according to some embodiments of the invention.

Ventilator 100 comprises a manifold housing 110 having four air chambers 112, 114, 116 and 118 shown in FIG. 1B. Chambers 112 and 114 are separated by piston wall 122. Similarly, chambers 116 and 118 are separated by piston wall 124. Rod connectors 123 and 125 are provided in piston walls 122 and 124 and are connected to piston rods or shafts 132 and 134 respectively.

Optionally, cylinders 127 and 129 are provided with which rod connectors 123 and 125 move. Cylinders 127 and 129 are optionally glass cylinders.

Chambers 112 and 116 are sealed at their lower ends by chamber plugs 126 and 128 respectively.

Piston rods 132 and 134 move linearly inside bushings 136 and 138 and move piston walls 122 and 124 respectively, thereby changing the dimensions and, as described below, the pressure in the air chambers. Each air chamber comprises two one-way valves, one inlet and one outlet valve. For example as shown in FIG. 1B, chamber 112 comprises of an inlet valve 232 and an outlet valve 222. The movement of the rods causes changes in the pressure in the air-chambers causing inlet valves to open and enter air in the air chambers when the pressure in the chamber decreases and the outlet valve to open and exit air from the air-chamber when the pressure in the air chamber is increased.

For example, when rod 132 moves down from the position shown in FIG. 1B, the pressure in chamber 112 is increased, thereby causing air to exit chamber 112 through valve 222. At the same time, air enters chamber 114 through its inlet valve. When the rods moves back up, the pressure in chamber 112 decreases, thereby causing air to enter through inlet valve 222. The same occurs in parallel chambers 116 and 118. Note that the motion of the movement of the pistons is 90 degrees out of phase such that for each complete cycle of the pistons the four chambers exhaust air at 90 degree intervals (four evenly spaced outputs over the cycle).

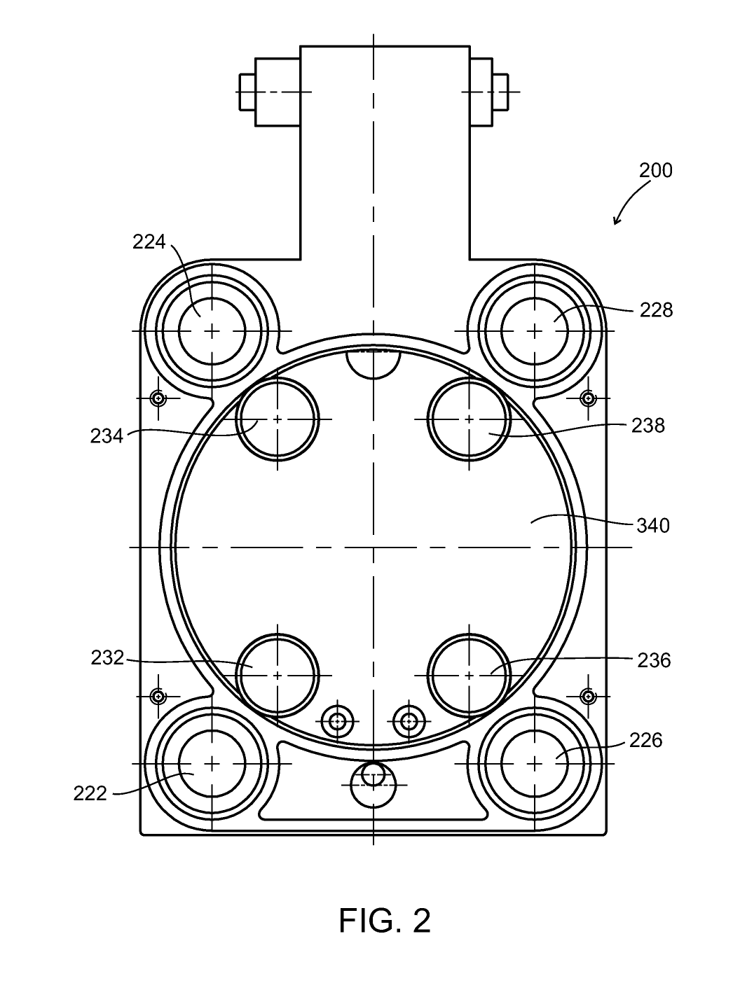

A manifold wall 200 as shown in FIG. 2 is provided on one side of the housing on the opposite side of the valves from the chambers. Wall 200 is fitted with four outlet valves 222, 224, 226 and 228 for exiting air from chambers 112, 114, 116 and 118 respectively. Manifold wall 200 is further fitted with four inlet valves 232, 234, 236 and 238 for inletting air into air chambers 112, 114, 116 and 118 respectively. A ring shaped wall 340 is provided, enclosing an air chamber wherefrom the inlet valves intake air. The air chamber is connected by an aperture to a side of the manifold which is opposite to the bushings, from which fresh air is inleted. Wall 340 is preferably made of an elastic material such as silicon and a casing is further provided on manifold wall 200, such that the air exited through outlet valves which enters the region between wall 340 and the casing, applies pressure on the outside of wall 340, assisting in forcing air through the inlet valves.

Rods 132 are generally reciprocated into and out of the housing any means known in the art, such as for example by the reciprocating devices of U.S. Pat. No. 5,762,480 and U.S. Pat. No. 7,654,802 incorporated herein by reference.

In some embodiments of the invention, rods 132 and 134 are driven by a motor positioned in a narrow extension 140 to housing 110 which is provided on an upper wall 115 of housing 110. A motor 150 is positioned in extension 140 and provides rotary motion. Optionally, motor 150 is a step motor.

Crank mechanisms 162 and 164 are positioned on upper wall 115 and are attached to motor 150 at the two sides thereof by crank rods 172 and 174 respectively. Crank mechanisms 162 and 164 are adapted to convert the rotary motion provided by motor 150 to reciprocating substantially linear motion for moving rods 132 and 134 inside bushings 136 and 138.

The principal operation of crank mechanisms 162 and 164 is similar to the operation of the crank mechanism described in U.S. Pat. No. 5,762,480 although having slightly different structure. FIG. 1A is a side view of ventilator 110 and shows the elements of crank mechanism 162. Crank mechanism 162 comprises four pivots, 202, 204, 206 and 208 which provide four pivot axes. Crank shaft 174 is connected to pivot 202 which is attached by a rod to pivot 204. Pivot 204 connects an L shaped rod 214 to pivot 206 and to piston rod 132. The rotary movement of pivot 202 is converted to a reciprocating substantially linear movement of rod 132 by pivots 204 and 206. Pivot 208 is attached by a supporting rod 176 (FIG. 1B) to motor 150 and provides support for the crank mechanism.

Rods 132 and 134 should preferably be made flexible in order to allow the rods to bend a bit when moving inside the bushings. In the embodiment shown in FIG. 1, the rods should bend by about 0.6 mm during operation. In some embodiments, the rods are made relatively thin in order to allow them to bend during operation. Optionally the diameter of the rods is between 0.5 mm-1.5 mm or 0.8 mm-1.2 mm, for example 1 mm.

It some embodiments, the rods are moved by other means known in the art, and the motor is positioned within housing 110, such that no extension is generally provided, for example, when the reciprocating device of U.S. Pat. No. 7,654,802 is used.

During operation, rods 132 and 134 tend to vibrate in the air chambers, which can cause high pitched noise. Without being limited to any theory, it is believed that the vibration of the rods is caused by friction due to movement of rods 132 and 134 in bushings 136 and 138. In addition, the vibration is increased when thin rods are used.

In some embodiments of the invention, a sleeve 182 is provided on one rod only, optionally, the rod which is more expected to vibrate. In some embodiments, a sleeve is provided on at least a portion of piston rod 134 for reducing the vibrating noise. Optionally, a similar sleeve 184 is provided on rod 132.

In some embodiments, sleeve 182 is provided on the lower portion of rod 132, close to rod connector 123, and covers at least 20%, 25%, 30%, 40%, 50%, 60% or 70% of the rod length. Optionally, the sleeve covers between 40%-60% of the rod length. For example, when the rod has a length of about 91.6 mm, the sleeve may cover about 47 mm of the rod. In some embodiments of the invention, the sleeve is provided on substantially the entire portion of the rod that does not move through the bushing.

In some embodiments of the invention, the sleeve has a thickness of between 0.2-2 mm, for example, between 0.5 mm-1.5 mm, such as about 1 mm. Optionally, the thickness of the sleeve is substantially the same as or less than the diameter of the rod, for example, when the rod has a diameter of 1 mm, the sleeve may have a thickness of 1 mm or less, resulting in a covered rod having a diameter of about 3 mm.

Optionally, the sleeve surrounds the entire diameter of the rod. Alternatively, the sleeve surrounds less than the entire diameter of the rod, leaving a slit along the rod's length which may allow placing the sleeve around the rod without taking the system apart. For example the sleeve may surround about 90% or more of the diameter of the rod. In some embodiments, the sleeve surrounds less than 90% of the rod's diameter.

In some embodiments, the sleeve is made of a flexible material that dampens optional vibrations of the rods. Optionally, the sleeve is made of a material having a density of about 1 g/cc. Optionally, the sleeve is made of a material having a hardness of between about 30 Shore A to 65 Shore A, for example between about 30-65 Shore A. Optionally, the sleeve is made of a material having tensile strength of between about 9-20 N/mm². Optionally, the sleeve is made of a material having elongation of between about 350%-500%. Optionally, the sleeve is made of a material having tear resistance of between about 19-40 N/mm. Optionally, the sleeve is made of silicon or rubber.

Optionally, the material is a food grade material that can resist heat (about 70° C.), 100% oxygen and 1.1 Atm pressure. Optionally, the sleeve is made of silicon or rubber.

FIG. 1B illustrates four air chambers and two crank mechanisms. However, some embodiments of the invention refer to a ventilator having only two air chambers and a single crank mechanism.

In the ventilator of FIG. 1B, the upper wall of the manifold housing is asymmetric in the sense that it is thicker at the side of bushing 136 and thinner at the side of bushing 138 in order to allow the motor to be inserted into the housing. In some embodiments, the upper wall at the side of bushing 136 is between about 80%-100% thicker than the upper wall at the side of bushing 138. For example, the upper wall at the side of bushing 136 may be about 4.8 mm thick while the upper surface at the side of bushing 138 may be about 2.7 mm thick. This however, reduces the available length (surrounded by housing material) for the bushing. This allows bushing to move, causing wear and sometimes causing the compressor to fail prematurely. In addition, the movement results in excessive noise during compressor operation.

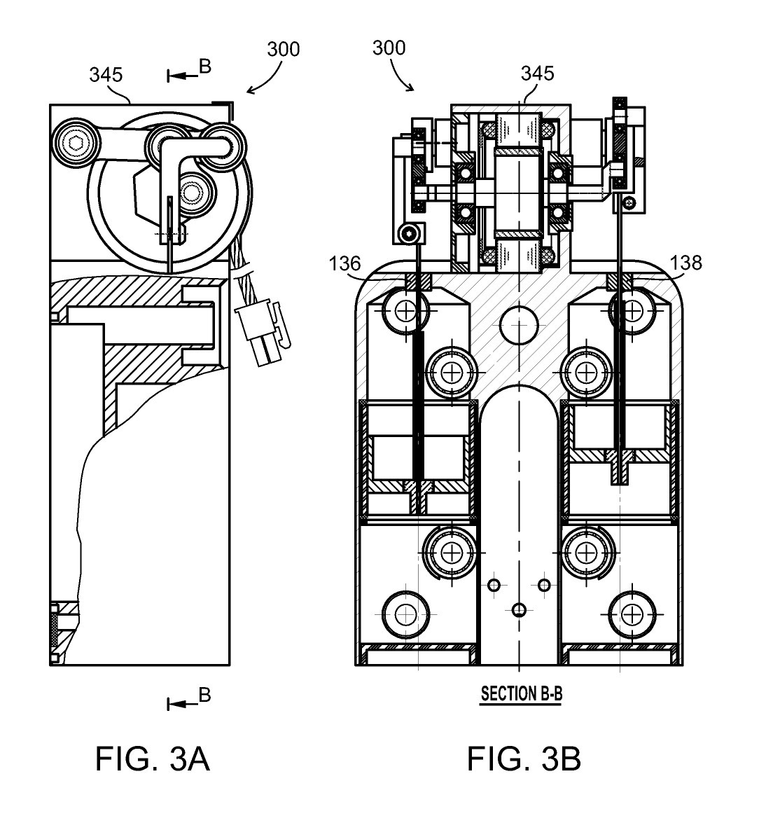

FIGS. 3A and 3B are cross-sectional and side views of an alternative manifold housing 300 according to some embodiments of the invention. In housing 300, the upper surface of the housing at the side of bushing 136 is substantially similar to the upper surface of the housing at the side of bushing 138. In some embodiments, the two sides have exactly the same thickness. For example, the thickness of the upper surface of the housing may be about 4.7 mm at both sides. Alternatively, the thickness of the upper surface of one side differs in about 10% with the upper surface of the other side of the housing.

In some embodiments of the invention, the upper surface 345 of the housing extension is made thicker than in the prior art manifold shown in FIG. 1B. The thicker upper surface reduces noise from the motor during operation. Optionally, upper surface 345 is between about 1 mm-3 mm thick, for example at least 2 mm thick.

Referring now back to the inlet and outlet valves of manifold wall 200, in some embodiments, the valves are any valve known in the art.

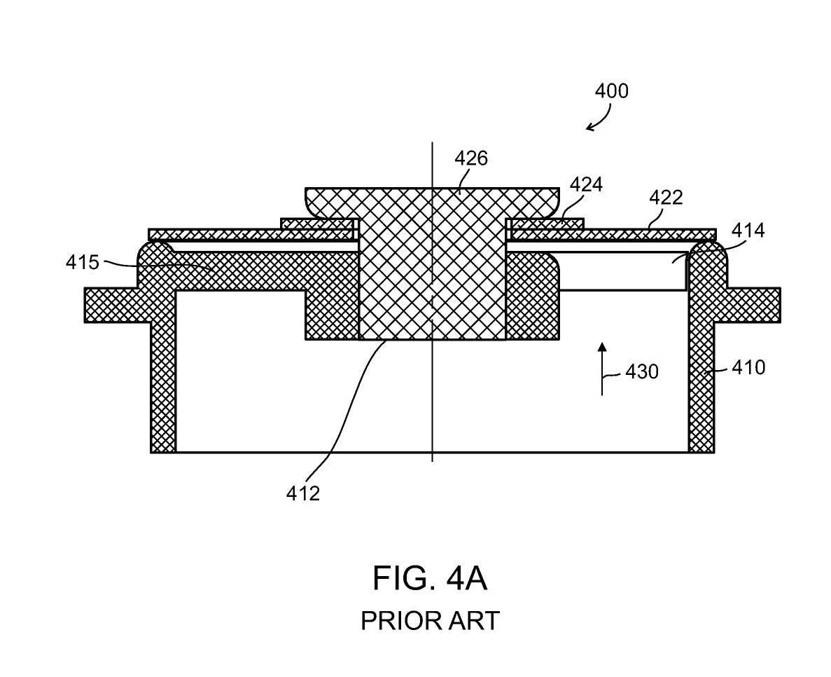

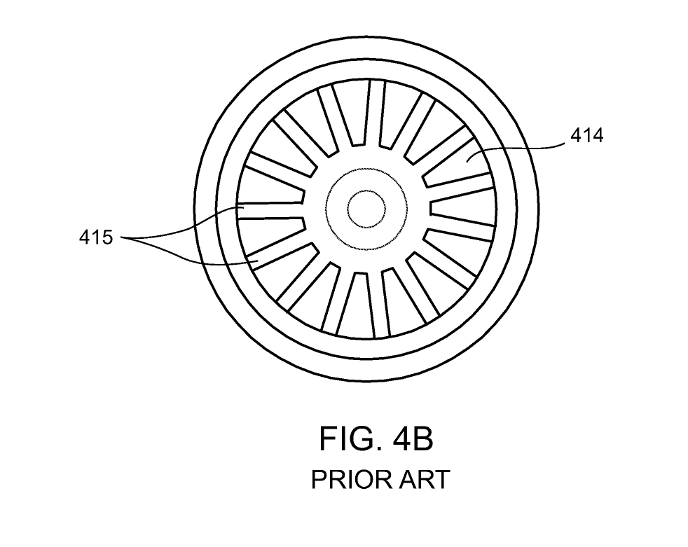

FIGS. 4A and 4B are a cross-section and a bottom view of an exemplary one-way valve 400 of the prior art. Valve 400 comprises of a valve housing 410 having a sealed aperture 412 and an air-aperture 414. Aperture 414 is covered by a diaphragm which comprises a first disk 422 and a second disk 424 having a smaller diameter than disk 422. As shown in FIG. 4B, aperture 414 is optionally ring (or cylinder) shaped and comprises a number of ribs or spokes 415 to hold disk 422 in place.

A plug 426 is provided for securing disks 422 and 424 together and/or for securing the disks to housing 410 by plugging the plug in aperture 412. During operation of the compressor, air flows through aperture 414, in the direction shown by arrow 430 and disks 422 and 424 bend to enable the air flow. By bending, friction between the disks and the plug occurs and may result in wear of the disks requiring relatively frequent valve replacement.

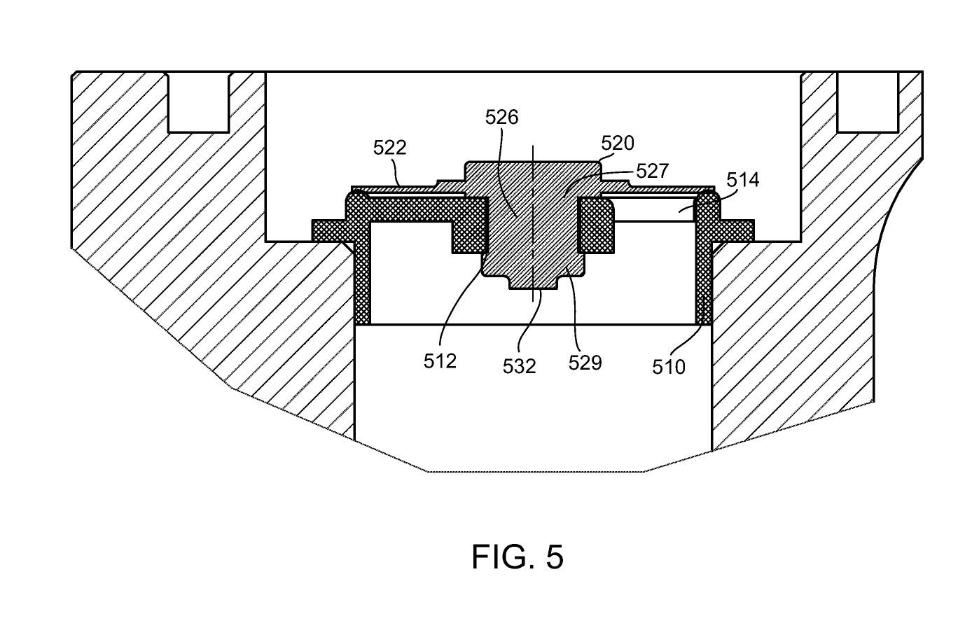

In some embodiments of the invention, an alternative one way valve 500 as shown in FIG. 5 is provided for one or more of inlet or outlet valves shown in FIGS. 1-3. Valve 500 comprises of a valve housing 510 having a sealed aperture 512 and an air-aperture 514. Aperture 514 is optionally ring shaped with ribs, similar to aperture 414 described with respect to FIG. 4.

A single unitary element 520 comprises both a plug 526 and diaphragm 522. Diaphragm 522 comprises of a disk with different thickness, optionally, the diaphragm 522 has a similar shape as disks 422 and 424 shown in FIG. 4, and comprises of two disks of different diameter which are connected to each other at the side of the plug and are provided as a single unitary element with plug 526. Alternatively, diaphragm 422 comprises of a single disk with different thickness, for example the diaphragm may have the same shape as disks 422 and 424 which are provided as a unitary piece with the plug and are connected along their entire surface.

Plug 526 has a proximal end 527 near the diaphragm and a distal end 529 having a cap which is separated from the proximal end by a shaft that fills aperture 512. Distal end 529 is preferably wider than aperture 512, thereby eliminating any tendency of the base from exiting through aperture 512 by the pressure caused during operation.

In some embodiments, an extension 532 is provided at the distal end of element 520, having a cross-section smaller than the base. Extension 532 may assist in pulling the base through aperture 512. Optionally, extension 532 is cut off after insertion through the aperture.

Valve 500 operates similarly to valve 400 shown in FIG. 4. Since element 520 is formed of a single (unitary) piece, friction between the base and diaphragm is eliminated, thereby increasing the life of the valve. Optionally, the life of valve 500 is increased by 50% relative to the prior art valve 400. For example, valve 500 may operate with an air flow of 70 LPM, air pressure varying in the range of 5 to 70 cmH₂O, for about 405 million cycles at a speed of about 23 m/s without requiring replacement. Optionally, the valve may operate during about 15,000 hours without requiring replacement.

Optionally, housing 510 is made of plastic. Optionally, element 520 is made of silicon, rubber or other suitable material.

As used herein the term “about” refers to ±10%

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a valve” or “at least one valve” may include a plurality of valves.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

1-10. (canceled)

11. A valve, comprising:
a valve housing having a first aperture and a second aperture; and
a unitary base element, comprising:
a diaphragm for covering the second aperture; and
a plug for plugging in the first aperture.

12. A valve according to claim 11, wherein the diaphragm comprises two disks of different diameters.

13. A valve according to claim 11, wherein the diaphragm comprises of a single disk with different thickness.

14. A valve according to claim 11, wherein the plug comprises an end distal from the diaphragm having a shaft and a cap with a larger diameter than the first aperture for holding the base element in the housing.

15. A valve according to claim 11, wherein the second aperture is ring shaped and comprises a plurality of ribs.

16. A valve according to claim 11, wherein the life of the valve is at least 405 million cycles at a speed of about 20 m/s.

17. A valve according to claim 11, wherein the unitary base element is made of silicone.

18. A manifold housing, comprising:
two bushings at an upper surface of the housing, the bushings having apertures for rods; and
at least two air chambers having air inlets and outlets,
wherein the wall thickness at the bushings at the upper surface of the housing differs by less than 10%.

19. A compressor comprising a manifold housing according to claim 18, and further comprising:
a rotary motor for operating the rods; and
two crank mechanisms, each attached to a rod, for transferring the rotary motion of the motor to reciprocating linear motion of the rods into the bushings.

20. A compressor according to claim 19, wherein the motor is situated at the upper surface of the housing, between the two bushings.

21. A compressor according to claim 20, wherein the wall of the housing at the upper surface of the motor is about 2 mm thick.
